(19) United States
(12) Patent Application Publication
(10) Pub. No.: US 2005/0262273 A1
(43) Pub. Date: Nov. 24, 2005

(54) Information processing apparatus having data input devices and method of processing input data information

(75) Inventors: Yoshiyuki Kikuchi, Tokyo (JP); Kazuhito Ohshita, Tokyo (JP)

Correspondence Address: BRINKS HOFER GILSON & LIONE, P.O. BOX 10395, CHICAGO, IL, 60610, US

(73) Assignee: ALPS ELECTRIC CO. LTD.

(21) Appl. No.: 11/127,680

(22) Filed: May 12, 2005

(30) Foreign Application Priority Data
May 20, 2004 (JP) 2004-150567

(51) Int. Cl. G06F 3/00; G06F 13/38

(52) U.S. Cl. 710/12; 345/156; 710/15; 710/72

(57) ABSTRACT

An information processing apparatus includes tracking process display units representing whether tracking processing functions are available or unavailable, tracking process determining units that determines whether to execute the tracking processes with reference to the tracking process display units, based on input mobile data, that outputs the mobile data when the tracking processing functions are available, and that ignores the mobile data when the tracking processing functions are unavailable, a tracking process executing unit to which the mobile data is input from the tracking process determining units and that executes the tracking processes, and an extension process executing unit which executes extension processes when extension data relating the extension process is input from data input devices.

### BACKGROUND OF THE INVENTION

1. Field of the Invention

The present invention relates to an information processing apparatus and an information processing method, and more particularly, to an information processing apparatus to which mobile data relating tracking processes and extension data relating extension processes are input by data input devices, serving as an information input devices, such as a mouse and the like, and to an information processing method.

2. Description of the Related Art

Conventionally, in addition to a keyboard and the like, serving as data input devices for inputting data to an information processing apparatus, pointing devices which move an indicating point of, for example, a cursor or a pointer on a display screen and that input coordinates of the indicating point on the display screen are generally used in the information processing apparatus, such as a personal computer (PC).

The pointing devices are used to input mobile data related to tracking processes for moving the indicating point and extension data related to extension processes for inputting the coordinates of the indicating point other than the tracking processes.

Also, in recent years, there has been proposed an information processing apparatus that has a plurality of pointing devices therein or to which the pointing devices can be connected.

An information processing apparatus having a plurality of pointing devices, for example, a notebook PC, is provide with a touch pad having one operating surface and two operating buttons as pointing devices in front of a keyboard as viewed by an operator. Also, a stick device, serving as another pointing device, is provided at an intersection point between predetermined keys on the keyboard.

The mobile data is input through the touch pad by touching and moving the operating surface by the finger, and the extension data is input by tapping the operating surface with holding down predetermined keys on the keyboard. In addition, the mobile data is input through the stick device by applying force back and forth and right and left with respect to the stick device, and the extension data is input by operating the stick device and a predetermined key on the keyboard at the same time.

The information processing apparatus having the plurality of pointing devices therein selectively uses only one of the pointing devices. However, in recent years, there has been proposed an information processing apparatus capable of using a plurality of pointing devices at the same time, from the viewpoint of an improvement in operationality (For example, see Japanese Unexamined Patent Application Publication No. 7-334294).

For example, in the above-mentioned information processing apparatus capable of simultaneously using the pointing devices, when various operations are performed using the touch pad, there is a fear that force will be applied to the stick device back and forth, and right and left by mistake. In this case, there is concern that an indicating point is moved to an unintended coordinate position due to the input of the mobile data by the careless operation of the stick device, so that an unintended coordinate position of the indication point is input.

For this reason, if the plurality of pointing devices can be used simultaneously, there is a problem in that the operationality of each pointing device is deteriorated.

### SUMMARY OF THE INVENTION

The present invention has been made to solve the above-mentioned problems, and it is an object of the present invention to provide an information processing apparatus and an information processing method capable of improving the operationality of each data input device in a case in which a plurality of data input devices are used simultaneously.

In order to achieve the above object, according to an aspect of the present invention, an information processing apparatus has a plurality of data input devices that input data related to tracking processes for moving an indicating point on the display screen and data related to extension processes other than the tracking processes. The information processing apparatus includes tracking process display units representing whether tracking processing functions of the data input devices are available or unavailable; tracking process determining units that determine whether to execute the tracking processes with reference to the tracking process display units, based on mobile data related to the tracking processes input through the data input devices, that outputs the mobile data when the tracking processing functions are available, and that ignores the mobile data when the tracking processing functions are unavailable; a tracking process executing unit to which the mobile data is input from the tracking process determining units and which executes the tracking processes; and an extension process executing unit which executes extension processes based on extension data related to the extension processes input through the data input devices.

In addition, the information processing apparatus may include a setting changing unit for changing the setting of the tracking processing functions of the tracking processing display units to be available or unavailable.

Further, the information processing apparatus may include extension process display units respectively representing whether the tracking processing functions of the data input devices are available or unavailable; and extension process determining units that determines whether to execute the extension processes with reference to the extension processing display units, based on extension data related to the extension processes input through the data input devices, that outputs the extension data when the extension processing functions are available, and that ignores the extension data when the extension processing functions are unavailable. In this case, the extension process executing unit inputs the extension data to execute the extension processes when the extension processing functions are available.

Furthermore, according to another aspect of the invention, there is provided an information processing method that executes tracking processes and extension processes, based on mobile data that is input through data input devices and that relates to the tracking processes for moving an indicating point on a display screen and extension data related to extension processes other than the tracking processes. The information processing method includes determining whether tracking processing functions are available or unavailable when the mobile data is input; ignoring the mobile data when the tracking processing functions are unavailable; executing the tracking processes on the basis of the mobile data when the tracking processing functions are available; and executing the extension processes on the basis of the extension data when the extension data is input.

According to the above-mentioned aspects of the invention, in the information processing apparatus and the information processing method, it is determined whether the tracking processing functions are available or unavailable, after the extension processing functions are to be available for the data input devices. Consequently, the tracking processes are performed on the basis of the input mobile data when the tracking processing functions are available. On the other hand, the mobile data is ignored when the tracking processing functions are unavailable.

### BRIEF DESCRIPTION OF THE DRAWINGS

FIG. 1 is a front view schematically illustrating an information processing apparatus according to an embodiment of the invention;

FIG. 2 is a block diagram illustrating the information processing apparatus shown in FIG. 1;

FIG. 3 is a flow chart illustrating an information processing method according to another embodiment of the invention; and

FIGS. 4A and 4B are flow charts illustrating an information processing method according to still another embodiment of the invention.

### DESCRIPTION OF THE PREFERRED EMBODIMENT

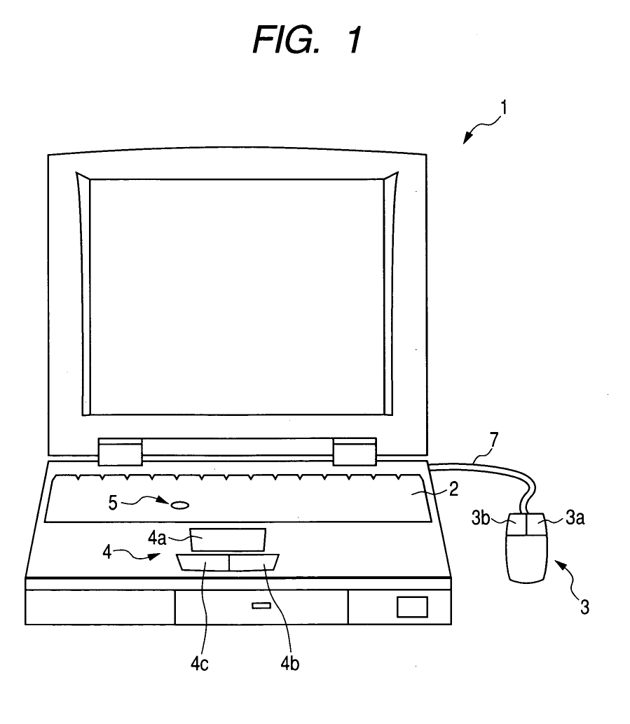

Hereinafter, a first embodiment of an information processing apparatus according to the invention will be described with reference to FIGS. 1 to 4.

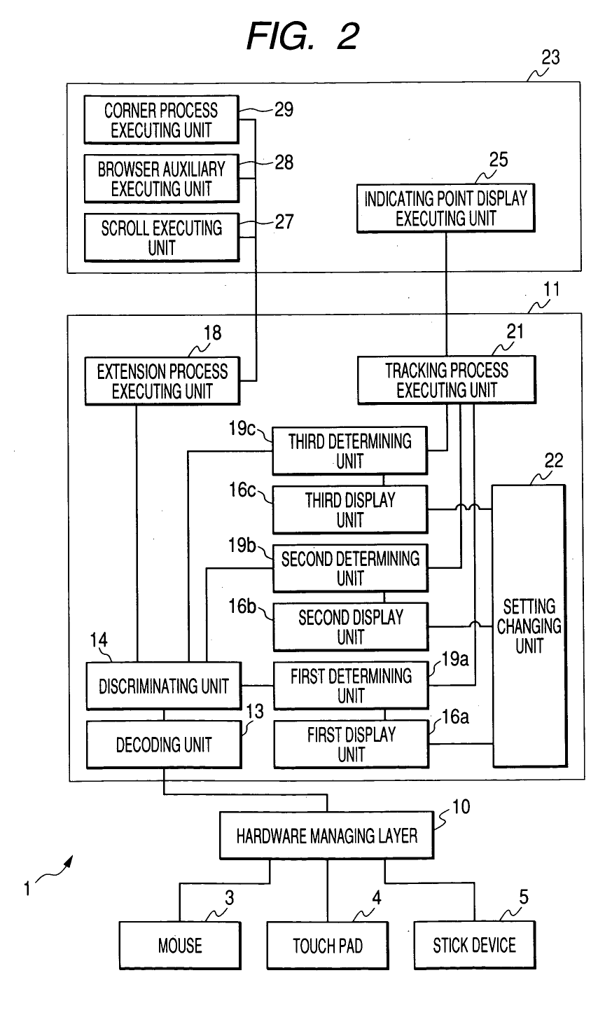

FIG. 1 is a perspective view schematically illustrating the information processing apparatus according to the present embodiment, and FIG. 2 is a block diagram of the information processing apparatus shown in FIG. 1.

As shown in FIG. 1, an information processing apparatus 1 according to the present embodiment has three pointing devices, such as a mouse 3, a touch pad 4, and a stick device 5, as data information input devices, besides a keyboard 2.

The mouse 3, the touch pad 4, and the stick device 5 are used to input, to the information processing apparatus 1, mobile data related to a tracking process for moving an indicating point on a display screen. Further, the mouse 3 or the like is used to input, to the information processing apparatus 1, extension data related to various extension processes other than the tracking process. In this case, the extension process includes a scroll process for scrolling a display screen, a corner setting process for setting corners of a window on the display screen, a corner performing process for allocating predetermined functions to the corners for the touch pad 4 and for executing the allocated functions by tapping the corners thereof, and a browser auxiliary process for replacing or coming forward with the display of the browser.

The mouse 3 is connected to the information processing apparatus 1 via a cable 7. Also, the mouse has a ball, rollers (not shown) for inputting the mobile data relating the tracking process and the extension data relating the extension processes, and right and left buttons 3a and 3b.

The touch pad 4 is provided at the front of the keyboard 2, as viewed by an operator, and has an operating surface 4a, a right button 4b, and a left button 4c for inputting the mobile data and the extension data.

The stick device 5 is provided at an intersection point between predetermined keys on the keyboard 2. The mobile data is input by applying force back and forth or right and left with respect to the stick device, and the extension data is input by operating the stick device 5 and a predetermined key of the keyboard at the same time.

As shown in FIG. 2, the information processing apparatus 1 is provided with a pointing device driver 11 to which the mouse 3, the touch pad 4, and the stick device 5 input the mobile data and the extension data via a hardware management layer 10, respectively.

The pointing device driver 11 has a decoding unit 13 for decoding encoded input data from the mouse 3 or the like, and the decoding unit 13 is output the decoded mobile data.

The pointing device driver 11 has a discriminating unit 14 for discriminating from which of the mouse 3, the touch pad 4, and the stick device 5 the input data from the decoding unit 13 is input and whether the input data is the extension data for executing the extension processes or the mobile data for executing the tracking process.

Also, the pointing device driver 11 has a first tracking process display unit 16a for displaying whether the tracking processing function with respect to the mouse 3 is available or unavailable, a second tracking process display unit 16b for displaying whether the tracking processing function with respect to the touch pad 4 is available or unavailable, and a third tracking process display unit 16c for displaying whether the tracking processing function with respect to the stick device 5 is available or unavailable. Each of the tracking process display units 16a, 16b, and 16c retains a flag when each function of the tracking processes is available.

Furthermore, the pointing device driver 11 has an extension process executing unit 18 which executes the extension process on the basis of the extension data input from the discriminating unit 14.

Further, the pointing device driver 11 has a first tracking process determining unit 19a to which the mobile data is input from the discriminating unit 14 through the mouse 3 and which determines whether the tracking processing function with respect to the mouse 3 is available or unavailable, with reference to the first tracking process display unit 16a. In addition, the pointing device driver 11 has a second tracking process determining unit 19b to which the mobile data is input from the discriminating unit through the touch pad 4 and which determines whether the tracking processing function with respect to the touch pad 4 is available or unavailable, with reference to the second tracking processing display unit 16b, and a third tracking process determining unit 19c to which the mobile data is input from the discriminating unit 14 through the stick device 5 and which determines whether the tracking processing function with respect to the stick device 5 is available or unavailable, with reference to the third tracking processing display unit 16c.

Each of the tracking process determining units 19a, 19b, and 19c outputs the mobile data when it is determined that each function of the tracking processes for the mouse 3, the touch pad 4, and the stick device 5 is available. On the contrary, each of the tracking process determining units ignores the mobile data when it is determined that each function of the tracking processes for the mouse 3, the touch pad 4, and the stick device 5 is unavailable.

Also, the pointing device driver 11 has a tracking process executing unit 21 that executes the tracking process on the basis of the mobile data input from each of the tracking process determining units 19a, 19b, and 19c.

In addition, the pointing device driver 11 has a setting changing unit 22 which changes setting for the tracking processing functions so as to be available or unavailable in each of the tracking processing display units 16a, 16b, and 16c.

When predetermined data is input from the keyboard 2 or the mouse 3, the setting changing unit 22 changes the setting of each of the tracking processing display units 16a, 16b, and 16c so that each function of the tracking processes is available or unavailable. As a result, when each function of the tracking processes is available, the setting changing unit 22 is set so that the flag is retained in each of the tracking processing display units 16a, 16b, and 16c. On the contrary, when each function of the tracking processes is unavailable, the setting changing unit 22 is set so that the flag is withdrawn in each of the in each of the tracking processing display units.

Also, the information processing apparatus 1 has an indicating point display executing unit 25 provided in an OS 23, and the indicating point display executing unit 25 displays an indicating point of a cursor or pointer on the basis of the mobile data from the tracking process executing unit 21. The indicating point display executing unit 25 executes a process of moving the indicating point on the display screen on the basis of the mobile data.

Further, the information processing apparatus 1 has extension process units including, for example, a scroll executing unit 27 for executing a scroll process, a browser auxiliary executing unit 28 for executing a browser auxiliary process, and a corner process executing unit 29 for executing a corner setting process, on the basis of the extension data from the extension process executing unit 18 in the OS 23.

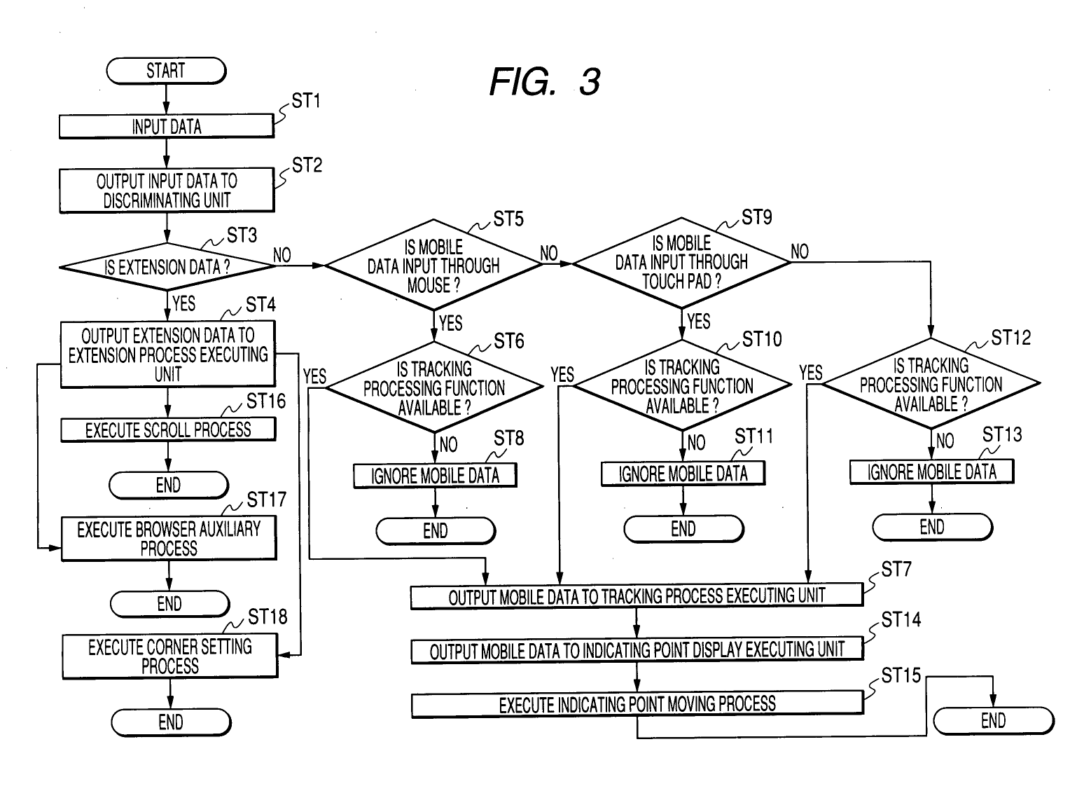

Next, an information processing method according to the invention which is executed by using the information processing apparatus 1 will be described with reference to FIG. 3.

When data is inputted through any one of the mouse 3, touch pad 4, and the stick device 5 (step ST1), in the information processing apparatus 1, the decoding unit 13 decodes the input data, and outputs the decoded data to the discriminating unit 14 (step ST2).

Subsequently, the discriminating unit 14 determines whether the input data is extension data or mobile data (step ST3). As a result, if the input data is extension data (‘YES’ in step ST3), the discriminating unit 14 outputs the extension data to the extension process executing unit 18 (step ST4).

On the contrary, if the input data is mobile data (‘NO’ in step ST3), the discriminating unit 14 determines whether the mobile data is input through the mouse 3 (step ST5).

In this case, if it is determined that the input data is the mobile data input through the mouse 3 (‘YES’ in step ST5), the discriminating unit 14 outputs the mobile data to the first tracking process determining unit 19a, and the first tracking process determining unit 19a determines whether the tracking processing function for the mouse 3 is available with reference to the presence or absence of the flag of the tracking process for the mouse 3 in the first tracking process display unit 16a (step ST6).

Then, if a flag relating the mouse 3 is retained in the first tracking process display unit 16a and it is determined that the tracking processing function for the mouse 3 is available (‘YES’ in step ST6), the first tracking process determining unit outputs the mobile data to the tracking process executing unit 21 (step ST7). On the contrary, if the flag relating the mouse 3 is not retained in the first tracking processing display unit and it is determined that the tracking processing function for the mouse 3 is unavailable (‘NO’ in step ST6), the first tracking process determining unit ignores the mobile data (step ST8).

Also, if the discriminating unit 14 determines that the mobile data is not input through the mouse 3 (‘NO’ in step ST5), the discriminating unit 14 determines whether the mobile data is input through the touch pad 4 (step ST9).

As a result, if it is determined that the mobile data is input through the touch pad 4 (‘YES’ in step ST9), the discriminating unit 14 outputs the mobile data to the second tracking process executing unit 19b, and then the second tracking process determining unit 19b determines whether the tracking processing function for the touch pad 4 is available with reference to the presence or absence of the flag of the tracking process for the touch pad 4 in the second tracking processing display unit 16b (step ST10).

Also, if it is determined that the tracking processing function for the touch pad 4 is available (‘YES’ in step ST10), the second tracking process determining unit outputs the mobile data to the tracking process executing unit 21 (step ST7). On the contrary, if it is determined that the tracking processing function for the touch pad 4 is unavailable (‘NO’ in step ST10), the second tracking process determining unit ignores the mobile data (step ST11).

In addition, if the discriminating unit 14 determines that the mobile data is not input through the touch pad 4 (‘NO’ in step ST9), it is determined that the mobile data is input from the stick device 5, and then the mobile data is output to the third tracking process determining unit 19c. The third tracking process determining unit 19c determines whether the tracking processing function for the stick device 5 is available with reference to the third tracking process display unit 16c (step ST12).

Further, if it is determined that the tracking processing function for the stick device 5 is available (‘YES’ in step ST12), the third tracking process determining unit outputs the mobile data to the tracking process executing unit 21 (step ST7). On the contrary, if it is determined that the tracking processing function for the stick device 5 is unavailable (‘NO’ in step ST12), the third tracking process determining unit ignores the mobile data (step ST13).

Next, after the mobile data is output to the tracking process executing unit 21, the mobile data is then output from the tracking process executing unit 21 to the indicating point display executing unit 25 (step ST14). The indicating point display executing unit 25 executes a process for moving the indicating point on the display screen on the basis of the mobile data (step ST15).

On the contrary, if the input data is extension data, it is determined which kind of extension process is executed on the extension data input from the extension process executing unit 18. As a result, if the extension data is for executing a scroll process, the extension data is output to the scroll executing unit 27, and the scroll executing unit 27 executes a process for scrolling the display screen (step ST16). Further, if the extension data is for executing a browser auxiliary process, the extension data is output to the browser auxiliary executing unit 28, and the browser auxiliary executing unit 28 executes a process for executing the browser auxiliary process (step ST17). In addition, if the extension data is for executing a corner setting process, the extension data is output to the corner process executing unit 29, and the corner process executing unit 29 executes a process for executing the corner setting of the window (step ST18).

Further, in a case in which the tracking processing functions for the mouse 3, the touch pad 4, and the stick device 5 are changed to be available or unavailable in the information processing apparatus 1, if setting changing data causing the tracking processing functions to be available is input through, for example, the keyboard 2, the setting changing unit 22 executes a process for allowing each of the tracking processing display units 16a, 16b, and 16c to retain the flag. On the contrary, if setting changing data causing the tracking processing functions to be unavailable is input, the setting changing unit 22 executes a process for withdrawing the flag of each of the tracking processing display units 16a, 16b, and 16c.

According to the present embodiment, in the information processing apparatus capable of simultaneously using a plurality of data input device, such as the keyboard 2, the mouse 3, the touch pad 4, and the stick device 5, it is possible to set the tracking processing functions to be available or unavailable by making the extension processing functions available for every data input device. For this reason, for example, when mobile data for a tracking process is input using the mouse 3 mainly, it is possible to set the tracking processing function for the mouse 3 to be available and to set the tracking processing functions for the touch pad 4 and the stick device 5 to be unavailable.

Consequently, in the above-mentioned case, although the operating surface 4a of the touch pad 4 or the stick device 5 is touched by mistake, it is possible to prevent an indicating point from being moved to an unintended position and to input the extension data by using the touch pad 4 or the stick device 5. Therefore, the operationality of the information processing apparatus 1 can be improved.

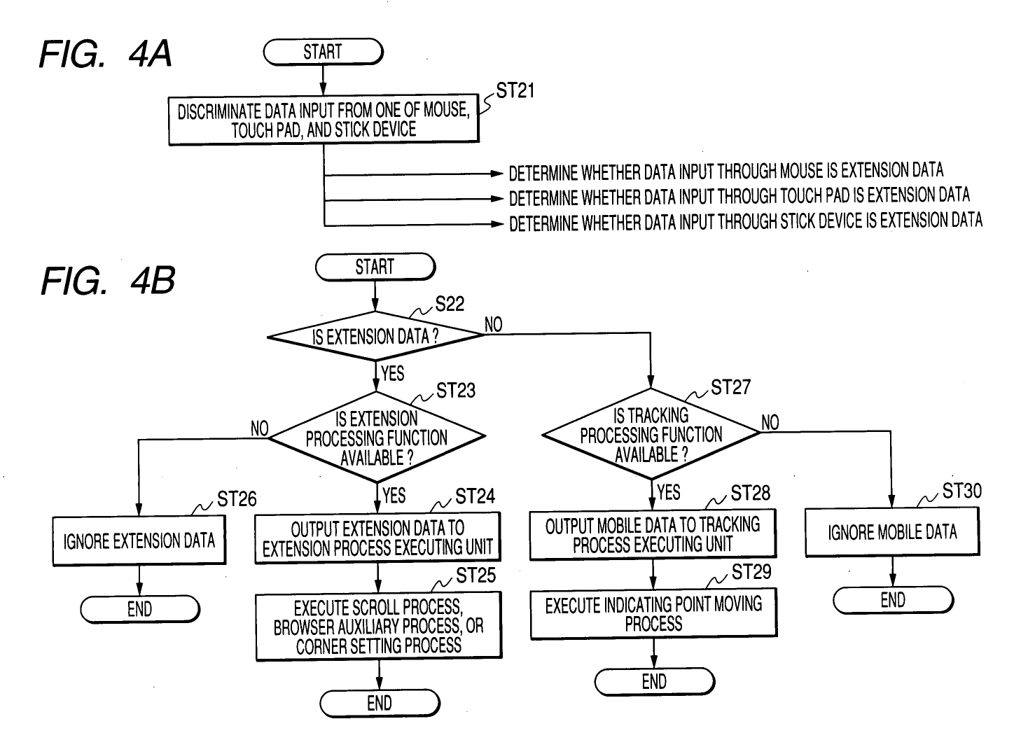

Next, a second embodiment of the invention will be described with reference to FIG. 4.

In addition, components having the same basic structures as those in the first embodiment have the same reference numerals.

An information processing apparatus 1 according to the second embodiment has a first extension process display unit representing that the extension processing function for the mouse 3 is available or unavailable, a second extension process display unit representing that the extension processing function for the touch pad 4 is available or unavailable, and a third extension processing display unit representing that the extension processing function for the stick device 5 is available or unavailable.

In addition, the information processing apparatus 1 has a first extension process determining unit (not shown) which determines whether the extension processing function for the mouse 3 is available or unavailable with reference to the first extension processing display unit. Further, the information processing apparatus has a second extension process determining unit which determines whether the extension processing function for the touch pad 4 is available or unavailable with reference to the second extension processing display unit and a third extension process determining unit which determines whether the extension processing function for the stick device 5 is available or unavailable with reference to the second extension processing display unit. Each of the extension process determining units outputs the extension data when it is determined that the extension processing function for the mouse 3, the touch pad 4, or stick device 5 is available. On the contrary, each of the extension process determining units is ignores the extension data when the extension processing function therefor is unavailable.

Since other structure of the information processing apparatus 1 according to the second embodiment are similar to those of the information processing apparatus 1 according to the first embodiment, the description thereof will be omitted in this specification.

Next, an information processing method executed by using the information processing apparatus according to the second embodiment will be described.

As shown in FIG. 4A, when the extension data or the mobile data is input to the information processing apparatus 1 through the mouse 3, the touch pad 4, or the stick device 5, the discriminating unit 14 determines through which of the mouse 3, the touch pad 4, and the stick device 5 the input data is input from the decoding unit 13 (step ST21).

Then, as shown in FIG. 4B, the discriminating unit 14 determines whether the input data input through the mouse 3 is extension data or mobile data, whether input data input through the touch pad 4 is extension data or mobile data, or whether input data input through the stick device 5 is extension data or mobile data (step ST22).

Further, if the input data is extension data input through the mouse 3, if the input data is extension data input through the touch pad 4, and if the input data is extension data input through the stick device 5 (‘YES’ in step ST22), each of the extension process determining units determines whether the extension processing functions of the mouse 3, the touch pad 4, and the stick device 5 are available, with reference to each extension processing display unit (step ST23).

When each of the extension process determining units determines that the extension processing functions of the mouse 3, the touch pad 4, and the stick device 5 are available (‘YES’ in step ST23), the extension data is output to the extension process executing unit 18 (step ST24). Then, like the first embodiment, the extension process determining units determine which extension process is executed for the extension data. On the basis of the determination, the extension process determining units output the extension data to the scroll executing unit 27, the browser auxiliary executing unit 28, or the corner process executing unit 29 to execute a scroll process, a browser auxiliary process, and a corner setting process on a display screen (step ST25).

On the contrary, when it is determined that the extension processing functions of the mouse 3, the touch pad 4, and the stick device 5 are unavailable (‘NO’ in step ST23), the extension data is ignored (step ST26).

In addition, if the input data is mobile data (‘NO’ in step ST22), like the first embodiment, it is determined whether the tracking process function for the mobile data is available or not (step ST27). Further, if the tracking processing functions of the mouse 3, the touch pad 4, and the stick device 5 are available (‘YES’ in step ST27), the mobile data is output to the tracking process executing unit 21 (step ST28), and then a process for moving an indicating point on the display screen is executed on the basis of the mobile data (step ST29). On the contrary, if the tracking processing functions of the mouse 3, the touch pad 4, and the stick device 5 are unavailable (‘NO’ in step ST27), the mobile data is ignored (step ST30).

Furthermore, in the information processing apparatus 1 according to the second embodiment, it is possible to change setting for the tracking processing functions to be available or unavailable and setting for the extension processing functions to be available or unavailable.

In the present embodiment, it also is possible to set the tracking processing functions to be available or unavailable for every data input device. In addition, it is possible to set the extension processing functions to be available or unavailable contrary to the tracking processing functions, in addition to setting the tracking processing functions. Therefore, the operationality of the information processing apparatus 1 can be improved.

In addition, the present invention is not limited to the first and second embodiments, and various modifications and changes of the invention can be made if necessary.

For example, in the present embodiment, it is determined whether the tracking processing functions of the mouse 3, the touch pad 4, and the stick device 5 are available or unavailable, but the invention is not limited thereto. It is possible to determine whether the tracking processing functions of data input devices including the keyboard 2 are available or unavailable.

As mentioned above, in the information processing apparatus and the information processing method according to aspects of the present invention, it is possible to prevent an indicating point from being moved to an unintended position by making the tracking processing functions of data input devices not mainly used unavailable, even if mobile data is input through the data input devices due to the unintentional contact of an operator. Further, since the extension data can be input by using the data input devices, the operationality of the information processing apparatus can be improved.

1. An information processing apparatus having a plurality of data input devices that input data related to tracking processes for moving an indicating point on a display screen and data related to extension processes other than the tracking processes, comprising:
tracking process display units representing whether tracking processing functions of the data input devices are available or unavailable;
tracking process determining units that determine whether to execute the tracking processes with reference to the tracking process display units, based on mobile data related to the tracking processes input through the data input devices, that outputs the mobile data when the tracking processing functions are available, and that ignores the mobile data when the tracking processing functions are unavailable;
a tracking process executing unit to which the mobile data is input from the tracking process determining units and which executes the tracking processes; and
an extension process executing unit which executes extension processes based on extension data related to the extension processes input through the data input devices.

2. The information processing apparatus according to claim 1, further comprising a setting changing unit that changes a setting of the tracking processing functions of the tracking process display units to be available or unavailable.

3. The information processing apparatus according to claim 1, further comprising:
extension process display units respectively representing whether the tracking processing functions of the data input devices are available or unavailable; and
extension process determining units that determines whether to execute the extension processes with reference to the extension processing display units, based on extension data related to the extension processes input through the data input devices, that outputs the extension data when the extension processing functions are available, and that ignores the extension data when the extension processing functions are unavailable,
wherein the extension process executing unit inputs the extension data to execute the extension processes when the extension processing functions are available.

4. An information processing method that executes tracking processes and extension processes, based on mobile data that is input through data input devices and that relates to the tracking processes for moving an indicating point on a display screen and extension data related to extension processes other than the tracking processes, comprising:
determining whether tracking processing functions are available or unavailable when the mobile data is input;
ignoring the mobile data when the tracking processing functions are unavailable;
executing the tracking processes on the basis of the mobile data when the tracking processing functions are available; and
executing the extension processes on the basis of the extension data when the extension data is input.
